(19) United States
(12) Patent Application Publication
(10) Pub. No.: US 2023/0093860 A1
(43) Pub. Date: Mar. 30, 2023

(54) METHODS OF PRODUCING ALUMINUM FLUORIDE FROM CRYOLITE BATH

(71) Applicant: ALCOA USA CORP., Pittsburgh, PA (US)

(72) Inventors: Xiangwen Wang, Murrysville, PA (US); Brian Zukas, Oakmont, PA (US)

(21) Appl. No.: 18/073,013

(22) Filed: Dec. 1, 2022

Related U.S. Application Data
(63) Continuation of application No. PCT/US2021/035741, filed on Jun. 3, 2021.
(60) Provisional application No. 63/070,584, filed on Aug. 26, 2020.
(60) Provisional application No. 63/036,829, filed on Jun. 9, 2020.

(51) Int. Cl. C01F 7/50; C25C 3/18

(52) U.S. Cl. CPC C01F 7/50; C25C 3/18

(57) ABSTRACT

New methods of producing aluminum fluoride from cryolite are disclosed. A method may include a step of reacting cryolite bath materials with aluminum sulfate, thereby producing a reactant product, the reactant product comprising aluminum fluoride. The method may further include a step of removing impurities from the reactant product, thereby creating a purified product comprising the aluminum fluoride. The removed impurities may comprise at least one of sodium (Na), magnesium (Mg), and calcium (Ca). In one embodiment, due to the removing step, the purified product contains not greater than 0.2 wt. % of calcium.

### CROSS-REFERENCE TO RELATED APPLICATION

This application is a continuation of International Patent Application No. PCT/US2021/035741, filed Jun. 3, 2021, which claims the benefit of U.S. Provisional Patent Application No. 63/070,584 filed Aug. 26, 2020, and U.S. Provisional Patent Application No. 63/036,829 filed Jun. 9, 2020, entitled “METHODS OF PRODUCING ALUMINUM FLUORIDE FROM CRYOLITE BATH,” each of which is incorporated herein by reference in its entirety.

### BACKGROUND

Production of aluminum by electrolysis of alumina is a well-known process. Commercial aluminum production is carried out in a reduction cell by the Hall-Heroult process in which alumina is dissolved in a molten electrolyte bath at a temperature of about 960-980° C. An electric current passing through the molten electrolyte reduces alumina to aluminum, which collects in a pool beneath the molten electrolyte bath. The molten electrolytic bath generally includes sodium cryolite (Na₃AlF₆) and aluminum fluoride (AlF₃) as well as other additives. See e.g., commonly-owned U.S. Pat. Nos. 6,440,294 and 6,942,381.

### SUMMARY OF THE DISCLOSURE

Broadly, the present patent application relates to methods of producing aluminum fluoride from cryolite bath materials. In one embodiment, and referring now to FIG. 1, a method (10) may include the step of reacting cryolite bath materials with aluminum sulfate (100). Due to the reacting step (100), a reaction (reactant) product is produced, which reaction product may comprise AlF₃ (102). Next, the method (10) may include the step of removing impurities from the reaction product (200), thereby creating a purified product. The impurities may comprise one or more compounds or elements of sodium (Na), magnesium (Mg) and calcium (Ca). In one embodiment, the purified product comprises the AlF₃ and not greater than 0.2 wt. % of calcium-containing byproducts (202). More details regarding the method are provided below.

I. Reacting Step (100)

Referring now to FIG. 2, in one embodiment, the reacting step (100) comprises reacting cryolite bath materials with aluminum sulfate. The aluminum sulfate may be hydrous or anhydrous aluminum sulfate, with anhydrous aluminum sulfate being preferred. The “cryolite bath materials” are materials having one or more of the following components: cryolite (Na₃AlF₆), chiolite (Na₅Al₃F₁₄), calcium cryolite (Na₂Ca₃AlF₆ and Na₂Ca₃Al₂F₁₄), and magnesium cryolite (e.g., Na₂MgF₄). Cryolite bath materials may be obtained, for instance, from an aluminum electrolysis cell. For purposes of the present patent application, cryolite bath materials do not include spent pot linings of aluminum electrolysis cells.

The reacting step (100) may be conducted batch wise or in a continuous manner. In one embodiment, a batch or rotary kiln is used. Irrespective of whether batch or continuous, the reacting step may comprise reacting the cryolite bath materials with the aluminum sulfate at a temperature of from 400-600° C. (110). In one embodiment, the reacting step (100) is conducted at a temperature of from 500-600° C. In one embodiment, the reacting step (100) comprises solid state reacting.

When a continuous reactor is used, the residence time may be not greater than 180 minutes (120). In one embodiment, the residence time is not greater than 150 minutes. In another embodiment, the residence time is not greater than 120 minutes. In yet another embodiment, the residence time is not greater than 90 minutes. In another embodiment, the residence time is not greater than 60 minutes. In yet another embodiment, the residence time is not greater than 30 minutes. In another embodiment, the residence time is not greater than 25 minutes. In yet another embodiment, the residence time is not greater than 20 minutes. In another embodiment, the residence time is not greater than 15 minutes. In yet another embodiment, the residence time is not greater than 10 minutes. Similar reaction times may be used with batch processing.

Generally, the reacting step (100) comprises using a stochiometric excess (130) of the aluminum sulfate. In one embodiment, not greater than 30 wt. % excess of aluminum sulfate is used. In another embodiment, not greater than 25 wt. % excess of aluminum sulfate is used. In yet another embodiment, not greater than 20 wt. % excess of aluminum sulfate is used. In another embodiment, not greater than 15 wt. % excess of aluminum sulfate is used. In yet another embodiment, not greater than 10 wt. % excess of aluminum sulfate is used. In another embodiment, not greater than 5 wt. % excess of aluminum sulfate is used.

II. Removing Impurities Step (200)

Referring now to FIG. 3A, in one embodiment, the removing step (200) comprises removing one or more of sodium (Na), magnesium (Mg), calcium (Ca) from the reactant product to create a purified product. For instance, due to the reacting step (100), one or more of sodium sulfate, magnesium sulfate and calcium sulfate may be included in the reactant product. In one embodiment, the removing includes a first sub-step of removing sodium (Na) and/or magnesium (Mg) materials in the reactant product (230), such as by washing the reactant product in a solvent (235), thereby transferring at least some of the sodium and/or magnesium to the solvent and creating an intermediate product. In one embodiment, the solvent is aqueous based. In one embodiment, the solvent is water. In one embodiment, the solvent is deionized water. The washing step (235) may be conducted at any appropriate temperature. In one embodiment, the washing step (235) is conducted at a temperature of not greater than 50° C. In another embodiment, the washing step (235) is conducted at a temperature of not greater than 40° C. In yet another embodiment, the washing step (235) is conducted at a temperature of not greater than 35° C. In another embodiment, the washing step (235) is conducted at a temperature of not greater than 30° C. Although not shown in FIG. 3A, the washing step (235) may also result in removal of some calcium (Ca) from the reactant product.

After the first removing step (230), the intermediate product may comprise low amounts of sodium and/or magnesium materials. In one embodiment, after the first removing step (230), the intermediate product comprises not greater than 1 wt. % Na and not greater than 0.1 wt. % Mg, and irrespective of whether in elemental or compound form.

After the first removing step (230), a second removing step (260) may be employed. The second removing step (260) may include the step of decomposing calcium byproducts (263) of the intermediate product. The decomposing step (263) may comprise, for instance, heating of the intermediate product to a temperature of from 800-1000° C. In one embodiment, the decomposing step comprises heating the intermediate product to a temperature of from 850-950° C. In one embodiment, the decomposing step comprises heating the intermediate product to a temperature of at least 900° C. Prior to the decomposing step (263), the intermediate product from the first reacting step (230) may be pretreated (not illustrated). For instance, after the first reacting step (230), the intermediate product may be washed (235), as already explained, and filtered. The washed and filtered intermediate product may then be dried to remove any excess water.

The decomposing step (263) generally comprises decomposing calcium byproducts, such as decomposing CaSO₄, into CaO. After the decomposing step (260), the intermediate product may be cooled (e.g., to room temperature), crushed/pulverized to create appropriate particle sizes of the intermediate product, and then washed in one or more solvents (266), thereby removing calcium from the intermediate product and creating a final purified product. For instance, after the decomposing step, an aqueous slurry comprising the intermediate product may be generated. Next, hydrochloric acid may be introduced into the slurry to convert CaO to CaCl₂ (calcium chloride). Next, the intermediate product may be washed in an aqueous solution, thereby removing at least some of the CaCl₂ from the intermediate product. The washing step may be conducted at any of the temperatures described above relative to the washing step used for the first removing step (230). Thus, the final product generally comprises AlF₃ and with very low amounts of impurities. In one embodiment, the final product comprises not greater than 0.2 wt. % Ca, and irrespective of whether in elemental or compound form. Moreover, in some instances, there is no need to mechanically press the purified product as the crushing/pulverization after the decomposing step (260) facilitates production of purified products of suitable form (e.g., of fine particulate form). In one embodiment, the final product is in fine particulate form, which may later be agglomerated. Suitable filtering apparatus/steps may be used between/with any of the steps (230, 260) or sub-steps (235, 263, 266) of FIG. 3A.

FIG. 3B illustrates an alternative embodiment for removing (200) impurities from the reactant product, including removing (230′) one or more of sodium (Na), magnesium (Mg), calcium (Ca) from the reactant product to create a purified product. Similar to FIG. 3A, the reactant product is first washed in a solvent and then dried (235). Next, however, the reactant product is heat treated (239) at a temperature of from 550° C. to 700° C. After the heat treatment, the heat treated material is washed in an acid (241). The acid may be HCl. In one embodiment, the acid is added to an aqueous slurry comprising the heat treated materials to reach a low pH. In one embodiment, acid is added until a pH of not greater than 2.5 is reached. In another embodiment, acid is added until a pH of not greater than 2.0 is reached. In yet another embodiment, acid is added until a pH of not greater than 1.5 is reached. In one embodiment, the final pH of the slurry is at least 1.0. After the appropriate pH is reached, the acid treated materials may be washed in water (243) and then dried. After the final washing step (243), a final, purified product may be realized. The final, purified product may contain low amounts of impurities, such as not greater than 1 wt. % Na, not greater than 0.1 wt. % Mg, and/or not greater than 0.2 wt. % Ca, and irrespective of whether in elemental or compound form. Again, in some instances, there is no need to mechanically press the purified product as a crushing/pulverization prior to the washing step (235) may be employed, so the final product may be in fine particulate form, which may later be agglomerated. Suitable filtering apparatus/steps may be used between/with any of the sub-steps (235)-(243) of the removing step (230′) of FIG. 3B.

In another embodiment, and still referring now to FIG. 3B, the heat treatment step (239) is not employed. That is, after the washing step (235), the washed and then dried reactant materials are acid washed (241), as described above, after which the method of FIG. 3B proceeds as per normal. This embodiment may be useful, for instance, when the sodium concentration in the reactant materials is sufficiently low (e.g., not greater than 5 wt. %).

Irrespective of the purifying method that is employed, the final purified products may then be used. In one embodiment, a final purified product is used an aluminum electrolysis cell. Thus, the methods disclosed herein show that cryolite bath materials generated in an aluminum electrolysis cell may be recycled for use as a pure or nearly pure feedstock for use in such aluminum electrolysis cells. In one embodiment, the final purified product comprises at least 96.0 wt. % AlF3, excluding any alumina (Al₂O₃) content of the final purified product. For instance, if a final purified product included 6 wt. % alumina, 92 wt. % AlF₃, 0.7 wt. % Na, 0.7 wt. % Ca and 0.6 wt. % Mg, then this final purified product contains 97.8 wt. % AlF₃ for purposes of this patent application because (92/(92+0.7+0.7+0.6))=97.8 wt. % AlF₃. In another embodiment, the final purified product comprises at least 97.0 wt. % AlF₃. In yet another embodiment, the final purified product comprises at least 98.0 wt. % AlF₃. In another embodiment, the final purified product comprises at least 98.5 wt. % AlF₃. In yet another embodiment, the final purified product comprises at least 99.0 wt. % AlF₃. In another embodiment, the final purified product comprises at least 99.5 wt. % AlF₃. In yet another embodiment, the final purified product comprises at least 99.8 wt. % AlF₃. In another embodiment, the final purified product comprises at least 99.9 wt. % AlF₃.

III. Preparing Step

Referring now to FIG. 4, in one embodiment, a method includes preparing the cryolite bath materials for the reacting step (100). For instance, a method may include creating a precursor mixture of the cryolite bath materials and the aluminum sulfate (50). The creating a precursor mixture step may include creating tailored sizes of cryolite bath particles (52), such as by one or more of grinding, crushing and/or pulverizing raw cryolite bath materials (54). In one embodiment, the creating step (52) comprises creating particles of the cryolite bath materials, wherein the particle comprise a size of not greater than −100 mesh. Similarly, aluminum sulfate materials may be in powdered form and may comprise particles of not greater than −100 mesh. In one embodiment, both cryolite bath materials and aluminum sulfate are created at the same time, e.g., by co-mingling/mixing the two materials followed by crushing/grinding of the mixture. The mixture may realize a particle size of not greater than-100 mesh.

IV. Miscellaneous

These and other aspects, advantages, and novel features of this new technology are set forth in part in the description that follows and will become apparent to those skilled in the art upon examination of the following description and figures or may be learned by practicing one or more embodiments of the technology provided for by the present disclosure.

The figures constitute a part of this specification and include illustrative embodiments of the present disclosure and illustrate various objects and features thereof. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, various embodiments of the invention may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references, unless the context clearly dictates otherwise. The meaning of “in” includes “in” and “on”, unless the context clearly dictates otherwise.

### BRIEF DESCRIPTION OF THE DRAWINGS

FIG. 1 is a flow chart illustrating one embodiment of a method for producing a purified aluminum fluoride product in accordance with the present disclosure.

FIG. 2 is a flow chart illustrating embodiments of the reacting step (100) of FIG. 1.

FIGS. 3A-3B are flow chart illustrating different embodiments of the removing step (200) of FIG. 1.

FIG. 4 is a flow chart illustrating embodiments of an optional preparing step (50) useful with the embodiments of FIG. 1.

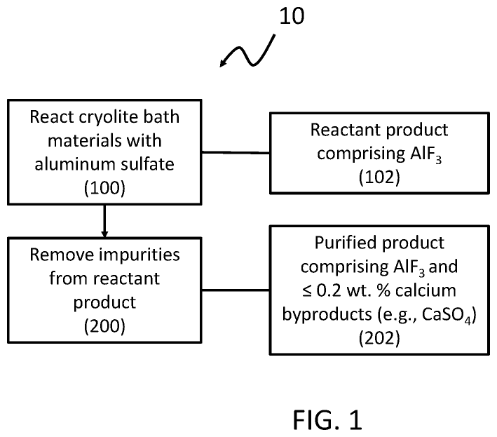

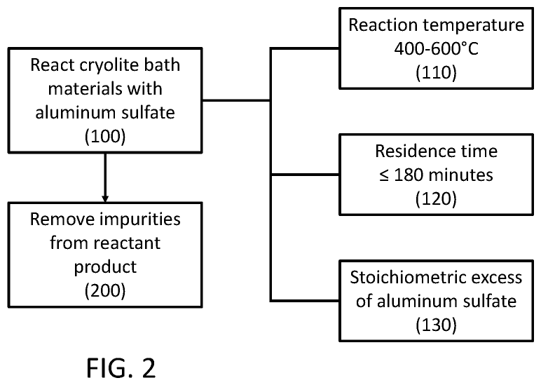

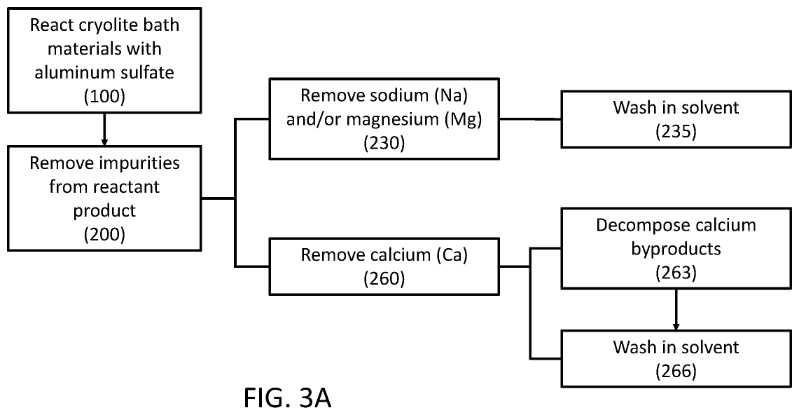

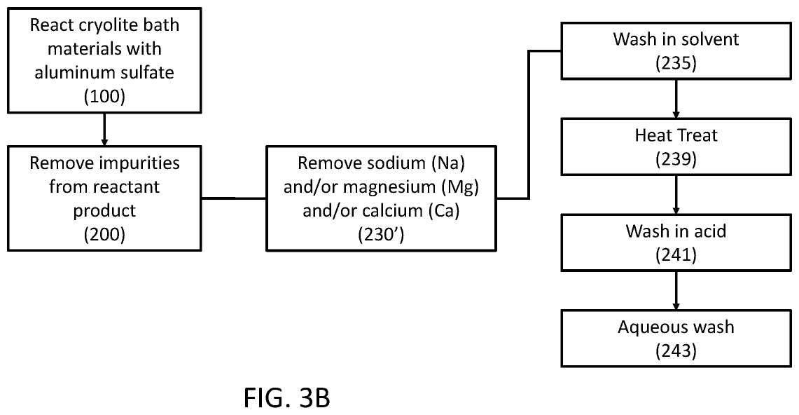

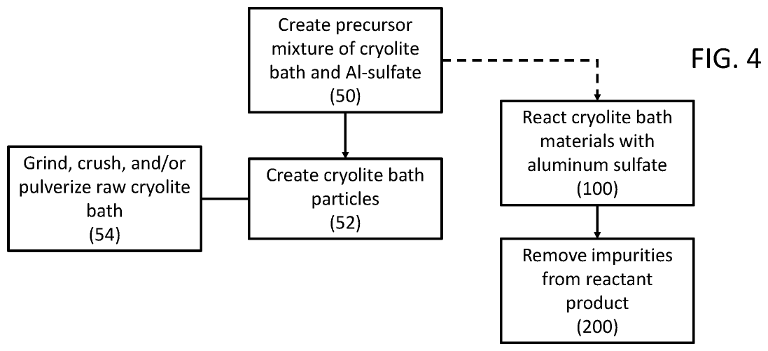

### DETAILED DESCRIPTION

### Example 1

Cryolite bath and anhydrous aluminum sulfate were mixed and then crushed/ground to 100 mesh. The materials were then heated to a temperature within the range of 500-600° C. for about 2.5 hours to facilitate their solid state reaction. After cooling to room temperature, the reactant products were ground, washed in water, filtered, and then dried by heating to about 110-120° C. The sodium, calcium and magnesium content of the reactant products is shown in Table 1, below, as measured by ICP.

Next, the dried products were heat treated a temperature within the range of 550-700° C. for about 2 hours and then cooled to room temperature. An aqueous slurry was then made using the heat treated products and water. HCl was added to the slurry until the pH was about 1.0-1.1. The acid treated materials were then washed and filtered and then dried by heating to about 110-120° C. The sodium, calcium and magnesium content of the final, purified product is shown in Table 1, below. As shown, the removal process removes all detectable amounts of calcium and magnesium and removes nearly all sodium.

TABLE 1
Impurity concentrations - Example 1 (wt. %)*

| Product | Sodium | Calcium | Magnesium |
|---|---|---|---|
| Rinsed Reactant Product | 6.8 | 1.1 | N.D. |
| Final, Purified Product | 0.34 | N.D. | N.D. |

*N.D. = below the analytic detection limit of 0.067 wt. % Ca or 0.055 wt. % Mg.

### Example 2

Reactant products made from cryolite bath and anhydrous aluminum sulfate were prepared generally as per Example 1. After cooling to room temperature, the reactant products were ground, washed in water, filtered, and then dried by heating to about 110-120° C. The sodium, calcium and magnesium content of the reactant products is shown in Table 2, below.

This time, an aqueous slurry was made from the dried products and water, i.e., a heat treatment was not completed. HCl was added to the slurry until the pH was about 1.0-1.1. The acid treated materials were then washed and filtered and then dried by heating to about 110-120° C. The sodium, calcium and magnesium content of the final, purified product is shown in Table 2, below. As shown, the removal process removes all detectable amounts of calcium and magnesium and removes nearly all sodium. This process may be used, for instance, when the sodium concentration in the reactant materials is below average.

TABLE 1
Impurity concentrations - Example 2 (wt. %)*

| Product | Sodium | Calcium | Magnesium |
|---|---|---|---|
| Final, Purified Product | 0.65 | N.D. | N.D. |

*N.D. = below the analytic detection limit of 0.067 wt. % Ca or 0.055 wt. % Mg.

While a number of embodiments of the present invention have been described, it is understood that these embodiments are illustrative only, and not restrictive, and that many modifications may become apparent to those of ordinary skill in the art. Further still, unless the context clearly requires otherwise, the various steps may be carried out in any desired order, and any applicable steps may be added and/or eliminated.

What is claimed is:

1. A method comprising:
(a) reacting cryolite bath materials with aluminum sulfate, thereby producing a reactant product, wherein the reactant product comprises aluminum fluoride; and
(b) removing impurities from the reactant product, thereby creating a purified product comprising the aluminum fluoride, wherein the impurities comprise at least one of sodium (Na), magnesium (Mg), and calcium (Ca), wherein, due to the removing step, the purified product contains not greater than 0.2 wt. % of calcium.

2. The method of claim 1, wherein the reacting comprises reacting at a temperature of from 400 to 600° C.

3. The method of claim 1, wherein the reacting comprises solid state reacting.

4. The method of claim 1, wherein the aluminum sulfate comprises anhydrous aluminum sulfate.

5. The method of claim 1, wherein the impurities comprise at least one sulfate.

6. The method of claim 5, wherein the at least one sulfate is at least one of sodium sulfate, magnesium sulfate and calcium sulfate.

7. The method of claim 1, comprising:
prior to the reacting step, creating a precursor mixture, wherein the precursor mixture comprises the cryolite bath materials and the aluminum sulfate.

8. The method of claim 7, wherein the creating step comprises creating particles of the cryolite bath materials.

9. The method of claim 8, wherein the creating particles comprises at least one of grinding, crushing, and pulverizing of raw cryolite bath materials.

10. The method of claim 1, wherein the removing comprises washing the reactant product with an aqueous solution.

11. The method of claim 10, wherein the aqueous solution is water or deionized water.

12. The method of claim 10, wherein the washing comprises transferring at least one of sodium sulfate and magnesium sulfate from the reactant product to the aqueous solution.

13. The method of claim 10, wherein the washing is conducted at a temperature of not greater than 50° C., or not greater than 40° C., or not greater than 35° C., or not greater than 30° C.

14. The method of claim 1, wherein the impurities comprise calcium byproducts, and wherein the method comprises decomposing at least some of the calcium byproducts, thereby producing calcium oxide materials.

15. The method of claim 14, wherein the decomposing comprises heating the reactant product to a temperature of at least 800° C., or at least 850° C. or at least 900° C.

16. The method of claim 14, comprising, after the decomposing step, removing at least some of the calcium oxide materials from the reactant product.

17. The method of claim 16, wherein the removing calcium oxide materials step comprises exposing the decomposed reactant product to a chloride-containing solution.

18. The method of claim 1, comprising heat treating the reactant product to produce a heat treated product, wherein the heat treating comprises heating the reactant product to one or more temperatures within the range of 550-700° C.

19. The method of claim 18, comprising contacting the heat treated product with an acid thereby producing an acid-treated product.

20. The method of claim 19, comprising, prior to the contacting, creating an aqueous slurry comprising the heat treated product;
wherein the contacting comprises adding the acid to the aqueous slurry.
